(19) United States
(12) Patent Application Publication
(10) Pub. No.: US 2007/0209723 A1
(43) Pub. Date: Sep. 13, 2007

(54) Actuating valve with ball column actuation

(76) Inventors: Santos Burrola, Juarez (MX); Alejandro Moreno, El Paso, TX (US)

Correspondence Address: DELPHI TECHNOLOGIES, INC., M/C 480-410-202, PO BOX 5052, TROY, MI, 48007, US

(21) Appl. No.: 11/369,471

(22) Filed: Mar. 7, 2006

(51) Int. Cl. F16K 31/02

(52) U.S. Cl. 137/625.65; 251/129.14

(57) ABSTRACT

A valve has a valve body defining an exhaust port, a supply port, and a control port all aligned with each other, and a plunger assembly reciprocates in the valve body under the influence of an actuating solenoid. Plural balls are disposed in alignment in the valve body to establish a ball column, with the plunger assembly contacting a first end of the ball column and a spring disposed in compression to push opposite the plunger assembly against the second end of the ball column. The balls move axially in unison between a closed configuration, wherein fluid communication between the supply and control ports is blocked, and an open configuration, wherein fluid communication between the supply and control ports is not blocked.

I. Field of the Invention

The present invention relates generally to valves for vehicle hydraulic systems such as automatic transmission systems.

II. Background of the Invention

Modern vehicles have many control systems in which a controller, in response to sensor signals, actuates vehicle components to control the vehicle. As one illustration, an engine control module (ECM) might receive input from various sensors and in response turn “on” and “off” actuation coils of various hydraulic valves to cause an automatic transmission to shift.

Spool valves are one type of valve that can be used for hydraulic control purposes. The valves in essence control the flow or pressure of the hydraulic fluid through various fluid chambers by causing a spool to slide within a valve housing, opening and closing various ports in the housing as it does so. Typically, the ports include a supply port that is connected to a hydraulic fluid supply, an exhaust port that exhausts fluid back to the hydraulic fluid supply, and a control port that is connected to the component sought to be controlled, e.g., to a transmission component.

Conventional spool valve designs require tight tolerances between the spool outer diameter and the housing inner diameter, because the clearance between the spool outer diameter and housing inner diameter determines the fluid leakage and flow/pressure control performance of the valve. As understood herein, the requirement for maintaining tight tolerances increases the cost of the valve.

Additionally, it is important that the magnetic, mechanical and hydraulic forces in the valve are adequately managed to produce the desired pressure or flow output. The present invention recognizes that friction, hydraulic stiction, component misalignment, under-damping, and other factors ideally should be minimized in to reduce actuator performance variation and enhance part reliability. With the above recognitions in mind, the present invention is provided.

### SUMMARY OF THE INVENTION

A valve includes a valve body defining at least one exhaust port, and may have an exhaust port at every end of the below-described column. The valve body also defines a supply port, and a control port, with the ports being aligned with each other. A plunger is at least partially disposed in the valve body and is reciprocally movable therein, and an actuating solenoid can be energized to cause the plunger to move. Plural balls are disposed in alignment in the valve body to establish a ball column. The plunger contacts a first end of the ball column, and the balls are movable in unison by the plunger between a closed configuration, wherein fluid communication between the supply and control ports is blocked, and an open configuration, wherein fluid communication between the supply and control ports is not blocked. A return spring is disposed in compression to push against the second end of the ball column.

If desired, a plunger assist spring can be disposed in compression to push against the first end of the ball column. In some implementations, a first ball in the column is smaller than a second ball in the column, with the first ball being circumscribed by an alignment ring and moving therewith. In specific non-limiting embodiments the ball column can include, in order from the plunger, the second ball, the first ball, a third ball having substantially the same diameter as the second ball, and a fourth ball having substantially the same diameter as the second ball, with each ball at all times contacting at least one adjacent ball. A spacer ring may be disposed intermediate the third and fourth balls.

In another aspect, a valve includes a valve body formed with at least supply, exhaust, and control ports. A column of rigid balls is movably disposed in the body and is juxtaposed with the ports, with each ball contacting at least one other ball in the column. Opposed force means are provided for selectively causing the column to reciprocate to establish a desired fluid flow configuration of the valve.

In still another aspect, a valve has a valve body formed with at least first and second ports, and an axially rigid port blocking structure includes plural independently movable segments. The port blocking structure is movably disposed in the body in juxtaposition with the ports. Opposed force means selectively cause the port blocking structure to reciprocate to establish a desired fluid flow configuration of the valve.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram showing the present valve in one non-limiting environment;

FIG. 2 is a cross-section of the valve in the closed configuration when the actuating solenoid is deenergized;

FIG. 3 is a cross-section of the valve midway between the closed configuration and open configuration just after the actuating solenoid has been energized;

FIG. 4 is a cross-section of the valve in the open configuration when the actuating solenoid is energized; and

FIG. 5 is an isometric view of an alignment ring.

### DETAILED DESCRIPTION OF THE PREFERRED EMBODIMENT

The present invention is intended for application in automotive vehicle systems and will be described in that context. It is to be understood, however, that the present invention could also be successfully applied in many other applications.

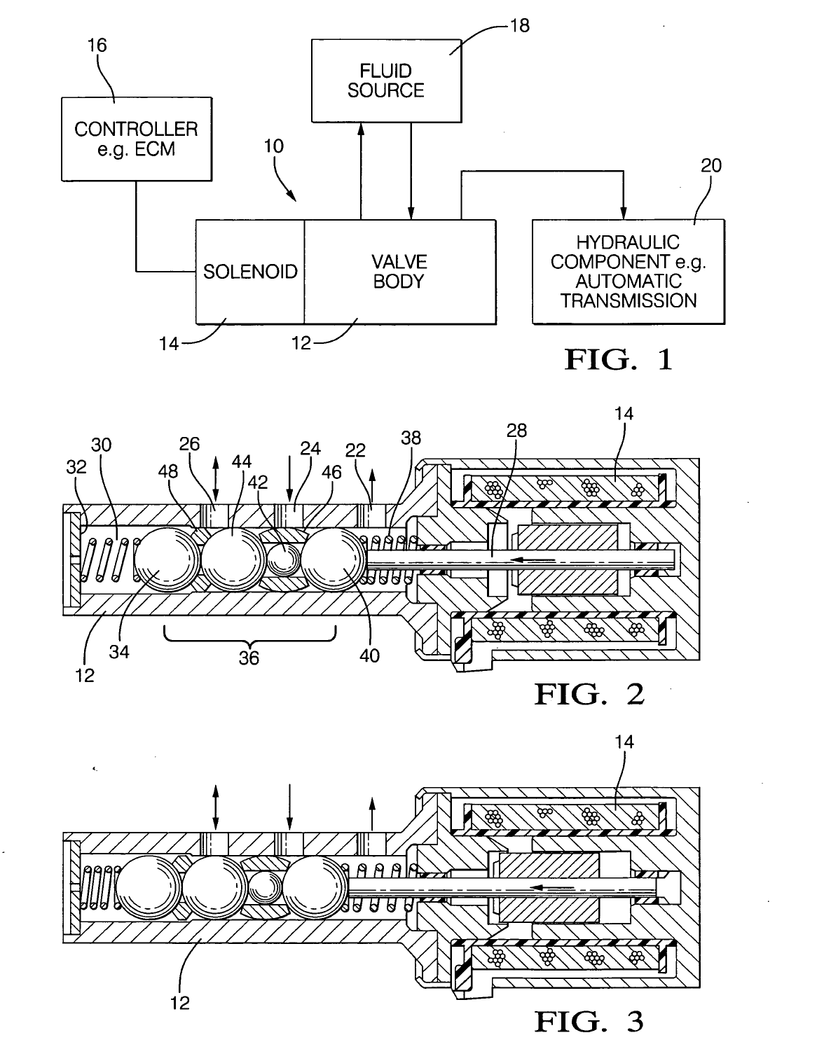

Referring initially to FIG. 1, a valve 10 is shown that includes a rigid valve body 12 and an actuating solenoid 14. The solenoid 14 can be energized and deenergized under the control of a controller 16 such as an engine control module (ECM) to move below-described components within the valve body 12 to selectively port hydraulic fluid from a fluid source 18 to and from a hydraulic component 20, such as a vehicle automatic transmission. Other applications include but are not limited to vehicle heavy equipment applications, engine cam phasing, etc.

FIGS. 2-4 show that the valve body 12 is formed with an exhaust port 22 and a supply port 24. The valve may also define a second exhaust port or orifice 25, and both of the exhaust ports 22, 25 can be connected to the fluid source 18 shown in FIG. 1 so that the net hydraulic force under these circumstances is zero and the magnetic force of the solenoid 14 essentially is counter to the net spring force of the below-described springs. Also, the valve body 12 is formed with a control port 26 that is connected to the hydraulic component 20 shown in FIG. 1. In the non-limiting implementation shown the ports 22, 24, 26 are aligned with each other.

A plunger/rod assembly 28 is disposed in the valve body 12 and is movable therein under the influence of the actuating solenoid 14, which can be energized to cause the plunger/rod assembly 28 to move to the left looking down in FIGS. 2-4. Also, when the solenoid 14 is deenergized the plunger/rod assembly 28 is forced to the right looking down in FIGS. 2-4 under the influence of a return spring 30, which is mounted in the valve body 12 in compression between the left end 32 of the valve body and the left-most ball 34 of an axially rigid column 36 of balls. If desired, a plunger assist spring 38 can be mounted in compression in the valve body 12 to abut against the right-most ball 40 of the column 36 of balls, to exert a leftward force on the column 36.

In the illustrative non-limiting embodiment shown, the column 36 of balls includes, from right to left, the right-most ball 40, a smaller ball 42, a ball 44, and the left-most ball 34, with the balls 34, 40, and 44 having substantially the same diameters as each other and with the small ball 42 having a relatively smaller diameter as shown. The balls 34, 40, 42, 44 are rigid and may be made of steel.

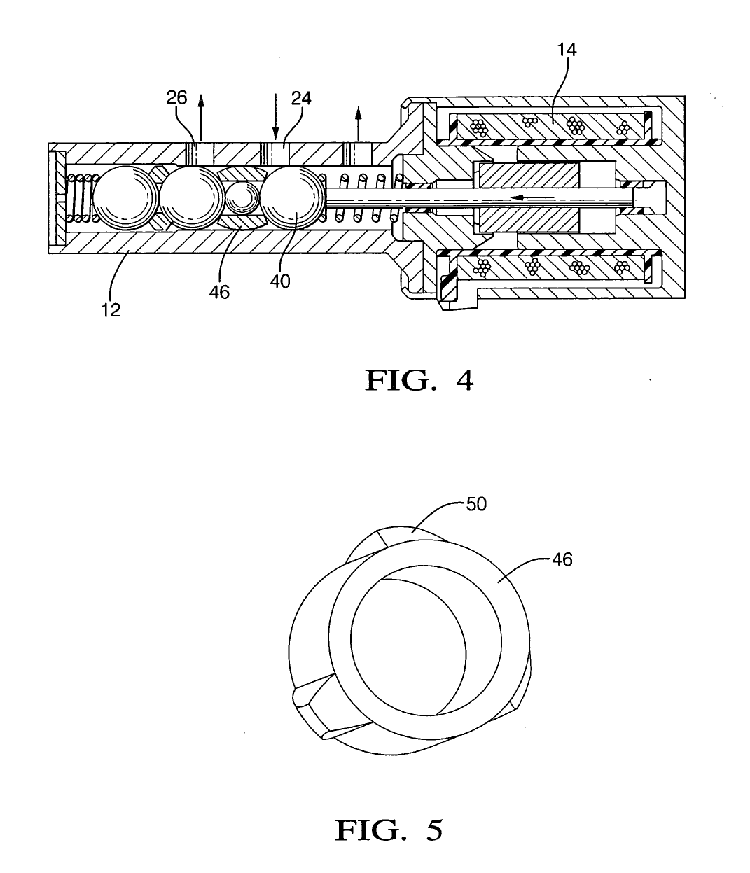

Accordingly, as shown in FIGS. 2-4 the balls 34, 40, 42, 44 are disposed in alignment with each other in the valve body to establish the ball column 36, with the plunger/rod assembly 28 at all times contacting the first end of the ball column and with the return spring 30 at all times contacting the opposite end of the column 36 in opposition to the plunger/rod assembly 28 (and in opposition to the plunger assist spring 38 when provided), so that the balls always remain in contact with each other. With this structure, the balls are movable in unison by the plunger/rod assembly 28 (upon energization of the solenoid 14) from the closed configuration shown in FIG. 2, wherein fluid communication between the supply and control ports 24, 26 is blocked by one or more of the balls, and the open configuration shown in FIG. 4, wherein fluid communication between the supply and control ports 24, 26 is not blocked.

It may now be appreciated that while the column 36 is axially rigid, the individual balls 34, 40, 42, 44 may rotate independently, decreasing friction as the column 36 moves. If desired, to maintain radial positioning the smaller ball 42 may be circumscribed by a hollow rigid alignment ring 46 (FIG. 5) and one or more spacer rings 48 may be disposed intermediate larger balls as shown. The alignment ring 46 may include outer axial contact flanges 50 as shown best in FIG. 5, with one or more flanges 50 riding against the inside wall of the valve body 12. With this structure in mind, it may now be appreciated that in the open configuration shown in FIG. 4, fluid can flow from the supply port 24, past the left-most ball 40, between the flanges 50 of the alignment ring 46, and out of the control port 26.

While the particular VALVE WITH BALL COLUMN ACTUATION as herein shown and described in detail is fully capable of attaining the above-described objects of the invention, it is to be understood that it is the presently preferred embodiment of the present invention and is thus representative of the subject matter which is broadly contemplated by the present invention, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. WE CLAIM:

What is claimed is:

1. A valve, comprising:
a valve body defining an exhaust port, a supply port, and a control port, the ports being aligned with each other;
a plunger assembly at least partially disposed in the valve body and reciprocally movable therein;
an actuating solenoid energizable to cause the plunger assembly to move;
plural balls disposed in alignment in the valve body to establish a ball column, the plunger assembly contacting a first end of the ball column, the balls being axially movable in unison by the plunger assembly between a closed configuration, wherein fluid communication between the supply and control ports is blocked, and an open configuration, wherein fluid communication between the supply and control ports is not blocked; and
at least a first spring disposed in compression to push against a second end of the ball column.

2. The valve of claim 1, comprising a second spring disposed in compression to push against the first end of the ball column.

3. The valve of claim 1, wherein at least a first ball in the column is smaller than a second ball in the column, the first ball being circumscribed by an alignment ring and moving therewith.

4. The valve of claim 3, comprising, in order from the plunger assembly, the second ball, the first ball, a third ball having substantially the same diameter as the second ball, and a fourth ball having substantially the same diameter as the second ball, each ball at all times contacting at least one adjacent ball.

5. The valve of claim 4, comprising a spacer ring disposed intermediate the third and fourth balls.

6. The valve of claim 1, wherein the control port is in fluid communication with a hydraulic component of a vehicle.

7. The valve of claim 6, wherein the hydraulic component is a portion of an automatic transmission.

8. A valve, comprising;
a valve body formed with at least supply, exhaust, and control ports;
a column of rigid balls movably disposed in the body and juxtaposed with the ports, each ball contacting at least one other ball in the column; and
opposed force means for selectively causing the column to reciprocate to establish a desired fluid flow configuration of the valve.

9. The valve of claim 8, wherein the means for selectively causing includes a plunger assembly disposed in perpetual contact with the column of rigid balls.

10. The valve of claim 9, wherein the means for selectively causing includes a spring disposed in perpetual contact with the column of rigid balls.

11. The valve of claim 8, wherein at least a first ball in the column is smaller than a second ball in the column, the first ball being circumscribed by an alignment ring and moving therewith.

12. The valve of claim 11, comprising, in order, the second ball, the first ball, a third ball having substantially the same diameter as the second ball, and a fourth ball having substantially the same diameter as the second ball, each ball at all times contacting at least one adjacent ball.

13. The valve of claim 12, comprising a spacer ring disposed intermediate the third and fourth balls.

14. The valve of claim 8, wherein the valve is in fluid communication with a hydraulic component of a vehicle.

15. The valve of claim 14, wherein the hydraulic component is a portion of an automatic transmission.

16. A valve, comprising;
a valve body formed with at least first and second ports;
an axially rigid port blocking structure including plural independently movable segments and movably disposed in the body in juxtaposition with the ports; and
opposed force means for selectively causing the port blocking structure to reciprocate to establish a desired fluid flow configuration of the valve.

17. The valve of claim 16, wherein the axially rigid port blocking structure is a column of balls and the plural independently movable segments are independently rotatable balls.

18. The valve of claim 17, wherein the means for selectively causing includes a plunger assembly disposed in perpetual contact with the column and a spring disposed in perpetual contact with the column.

19. The valve of claim 17, wherein at least a first ball in the column is smaller than a second ball in the column, the first ball being circumscribed by an alignment ring and moving therewith.

20. The valve of claim 16, wherein the valve is in fluid communication with a portion of an automatic transmission.
